(19) United States
(12) Patent Application Publication
(10) Pub. No.: US 2020/0376775 A1
(43) Pub. Date: Dec. 3, 2020

(54) CASTING TECHNIQUES, CASTS, AND THREE-DIMENSIONAL PRINTING SYSTEMS AND METHODS

(71) Applicant: DDM SYSTEMS, INC., Atlanta, GA (US)

(72) Inventors: Suman DAS, Atlanta, GA (US); John HALLORAN, Ann Arbor, MI (US); Marvin KILGO, Atlanta, GA (US)

(73) Assignee: DDM SYSTEMS, INC., Atlanta, GA (US)

(21) Appl. No.: 16/970,494

(22) PCT Filed: Feb. 15, 2019
(86) PCT No.: PCT/US2019/018347

§ 371 Date: Aug. 17, 2020

Related U.S. Application Data
(60) Provisional application No. 62/630,898, filed on Feb. 15, 2018.

(51) Int. Cl. B29C 64/393; B33Y 10/00; B33Y 30/00; B33Y 50/02; B29C 64/124

(52) U.S. Cl. CPC B29C 64/393; B33Y 10/00; B29C 64/124; B33Y 50/02; B33Y 30/00

(57) ABSTRACT

A system including: an optical light source; a reservoir configured to hold a liquid photosensitive medium that is adapted to change states upon exposure to a portion of light from the optical imaging system; and a control system configured to control the optical light source to expose specified portions of a surface the photosensitive medium contained in the reservoir to light from the light source. The control system may be further configured to control the optical light source to repeatedly expose the surface of the photosensitive medium contained in the reservoir to light from the light source to build layers of a desired object.

### CROSS-REFERENCE TO RELATED APPLICATION

This application claims benefit under 35 U.S.C. § 119(e) of U.S. Provisional Patent Application No. 62/630,898, filed Feb. 15, 2018. The entire contents and substance of the above application is incorporated herein by reference in its entirety as if fully set forth below.

### FIELD

The presently disclosed subject matter relates generally to casting and, more particularly, to improvements to casting techniques, casts, and three-dimensional printing systems and methods.

### BACKGROUND

Investment casting or “lost-wax casting” is a well-established metal-forming technique. In the traditional approach, (typically wax) models are formed into a “tree” assembly with a central sprue (“trunk”), individual part models, and a filling cup. In some cases, “branches” or arms may extend from the sprue to the individual part models. A ceramic mold (investment) or cast is made by coating the tree assembly and stuccoing and hardening the slurry. The coating, stuccoing and hardening are repeated until the investment has a desired thickness. The ceramic molds are then dried, which can take several days. Once ceramic molds are dried, they are turned upside-down and heated (e.g., in a furnace or autoclave) to melt out and/or vaporize the wax. The dewaxing process is a common source for failure as the waxes have a much greater thermal expansion coefficient than the ceramic mold. Thus, as the wax is heated, it rapidly expands and can crack the mold. Once the mold is prepared, metal is poured into the ceramic mold, filling the mold. The metal may be gravity poured or forced in (e.g., by applying positive air pressure). The mold may also be filled using, for example, vacuum casting, tilt casting, pressure assisted pouring and centrifugal casting. The metal is cooled, and the cast is broken away from the cooled metal. The parts are cut off from the sprue and finished.

The traditional approach is a laborious and time-consuming process that may lead to failure after hours or days of effort. Moreover, such approaches create uncontrollable shell-sizes of substantially uniform compositions. This causes unacceptable or defective castings, wasted effort, and wasted resources.

Certain related art methods attempt to address some of these issues utilizing three-dimensional (3D) printing techniques to directly produce ceramic castings. With 3D printing, a mold CAD file is provided to a 3D printer-system which produces a complete ceramic mold. Certain approaches to 3D printing are known to those of ordinary skill, such as those discussed in PCT Publication App. PCT/US2013/069349 filed on Nov. 11, 2013 and published as WO2014/074954 on May 15, 2014, the disclosure of which is incorporated herein by reference in its entirety as if fully restated, and variations thereto will be obvious to one of ordinary skill in light of the present disclosure.

However, even with 3D printing, there continue to be limitations to the related art approaches. For example, as the metal is cooled, it undergoes volumetric shrinkage. If the cast is overly strong, the metal cannot shrink as needed, and the metal part undergoes hot tearing. 3D printing methods may result in inexact casts due to scattering, medium growth or shrinkage, and/or inexact cure depth. Therefore, what is needed is a way to improve the efficiency and flexibility of 3D printing and investment casting.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1 is a flowchart of conventional investment casting of 3D objects.

FIGS. 2-5 are perspective views of example 3D printing systems according to example embodiments.

FIGS. 6A and 6B depict perspective and top views of a cylinder cast according to an example embodiment.

FIG. 7 depicts a cast shell according to an example embodiment.

FIG. 8 depicts a caste core according to an example embodiment.

FIGS. 9-16 are flowcharts of methods according to example embodiments.

FIG. 17 is a computer device architecture diagram.

### SUMMARY

According to some embodiments there is provided a system for fabricating a three-dimensional object, the system including: an optical light source; a reservoir configured to hold a liquid photosensitive medium that is adapted to change states upon exposure to a portion of light from the optical imaging system; and a control system configured to control the optical light source to expose specified portions of a surface the photosensitive medium contained in the reservoir to light from the light source. The control system may be further configured to control the optical light source to repeatedly expose the surface of the photosensitive medium contained in the reservoir to light from the light source to build layers of a desired object.

The desired object may be a cast and may include a shell. The shell may include an inner surface and a shell internal structure. The shell internal structure may include at least one of sub-millimeter interior features and micro-architecture features. The shell internal structure may include at least one of a lattice or a truss. The shell internal structure may include at least one tube. The shell internal structure may be rigid against flexure and axial compression by weak against radial compression.

The shell may be selectively weak against radial compression. The shell internal structure may incorporate features to enhance leachability. The shell internal structure may include includes at least one internal passageway. The shell internal structure is substantially porous. The shell may include at least one channel.

The shell may further include an outer surface, the shell internal structure being deposed between the inner surface and the outer surface. The outer surface may include one or more attachment points.

The control system may be further configured to: receive a cast design; determine a desired attachment point for the shell; and modify the cast design to include the desired attachment point. The control system may be further configured to: receive a cast design; determine a desired shell internal structure for the shell; and modify the cast design to include the desired shell internal structure. The control system may be further configured to control the optical light source to repeatedly expose the surface of the photosensitive medium contained in the reservoir to light from the light source to build layers of the cast in accordance with the modified cast design.

The cast may further include a core. The core may include a surface and a core internal structure. The core internal structure may include at least one of sub-millimeter interior features and micro-architecture features. The core internal structure may include at least one of a lattice or a truss. The core internal structure may include at least one tube. The core internal structure is rigid against flexure and axial compression by weak against radial compression. The core may be selectively weak against radial compression.

The core internal structure includes features to enhance leachability of the core. The core internal structure includes at least one internal passageway. The core may include at least one channel. The core internal structure may be substantially porous.

At least one of the shell internal structure and the core internal structure is conditioned to control heat transfer in the shell or core.

The control system may be further configured to: receive a cast design; determine a desired core internal structure for the core; and modify the cast design to include the desired core internal structure. The control system may be further configured to control the optical light source to repeatedly expose the surface of the photosensitive medium contained in the reservoir to light from the light source to build layers of the cast in accordance with the modified cast design.

The system may further include a depositor configured to deposit one or more secondary substances across a build surface. The depositor may include an articulating arm. The depositor may include an inkjet printer configured to print the secondary substances across the build surface.

The system may further include an XY scanning stage, the depositor being mounted on the XY scanning stage. The system may further include an XY scanning track, the depositor being mounted on the XY scanning track.

The one or more secondary substances includes at least one from among a photoinhibitor, a photoinitiator, a monomer, and one or more secondary photopolymerizable suspensions, the one or more secondary photopolymerizable suspensions being distinct from the photosensitive medium. The photoinhibitor may include a light absorbing dye.

The control system may be further configured to control the depositor to selectively deposit the one or more secondary substances across a build surface. The control system may be further configured to control the depositor to selectively deposit a photoinhibitor to limit curing of the photosensitive medium beneath the photoinhibitor. The control system may be further configured to control the depositor to selectively deposit a photoinhibitor around an edge of a current layer being built. The control system may be further configured to control the depositor to selectively deposit a photoinitiator to locally increase photocuring reactivity of the photosensitive medium beneath the photoinitiator. The control system may be further configured to control the depositor to selectively deposit one or more secondary photopolymerizable suspensions to provide a multi-layered object when cured. The control system may be further configured to control the depositor to selectively deposit the one or more secondary photopolymerizable suspensions across the build surface following application of a current layer of the photosensitive medium, but prior to curing the current layer of the photosensitive medium. The control system may be further configured to control the depositor to selectively deposit the one or more secondary photopolymerizable suspensions across the build surface following curing a previous layer of the photosensitive medium, but prior to application of the current layer of the photosensitive medium.

The control system may be further configured to: determine at least one photosensitive medium and curing property; modify an image slice based on the at least one photosensitive medium and curing property; and control the optical light source to expose specified portions of a surface the photosensitive medium contained in the reservoir to light from the light source based on the modified image slice. The control system may be further configured to: determine at least one photosensitive medium and curing property; and modify an intensity of the light source based on the at least one photosensitive medium and curing property.

The photosensitive medium and curing property includes at least one from among light scattering, side scattering, shrinkage, print-through, curing expansions, polymerization shrinkage, sintering shrinkage, broadening behavior of a suspension of the photosensitive medium, optical properties of the suspension medium, absorption coefficient of the suspension medium, refractive index of the suspension medium, optical properties of powders in the suspension, absorption of the powders in the suspension, refractive index of the powders in the suspension, powder particle size distribution, changes due to subsequent processing and/or heat treatment.

Modifying the image slice may include at least one of making positive and/or negative boundary corrections of the image slice and inserting a keyhole for a corner of the image slice.

The control system may be further configured to determine the at least one photosensitive medium and curing property by performing physics-based simulations to estimate the at least one photosensitive medium and curing property. The control system may be further configured to determine the at least one photosensitive medium and curing property by retrieving stored information about the at least one photosensitive medium and curing property.

The control system may be further configured to control the optical imaging system to expose specified portions of a surface the photosensitive medium contained in the reservoir to light from the light source based on one or more a calibration images to form one or more test layers. The system may further include one or more image capturing devices. The control system may be further configured to control the one or more image capturing devices to capture a geometry of the one or more test layers. The control system may be further configured to compare the captured geometry of the one or more test layers to the one or more calibration images to determine the at least one photosensitive medium and curing property.

The control system may be further configured to: control the one or more image capturing devices to capture a geometry of one or more cured layers; compare the captured geometry of the one or more cured layers to an intended geometry of the one or more cured layers; and determine the at least one photosensitive medium and curing property based on the comparison.

The one or more image capturing devices may include at least one from among a camera, an infrared sensor, a laser grid emitter, and a three-dimensional (3D) scanner.

According to some embodiments, there is provided a method including: determining a geometry of a current layer; and controlling an optical light source to expose specified portions of a surface of photosensitive medium to light from the light source consistent with the geometry of the current layer. The method may further include repeatedly exposing the surface of the photosensitive medium to light from the light source to build a plurality of layers a desired object. The desired object may include a cast including a shell.

The shell may include an inner surface and a shell internal structure. The method may further include repeatedly exposing the surface of the photosensitive medium to light from the light source to build the shell including the shell internal structure. The shell internal structure may include at least one of sub-millimeter interior features and micro-architecture features. The shell internal structure may include at least one of a lattice, a truss, or a tube. The shell internal structure may be rigid against flexure and axial compression by weak against radial compression. The shell may be selectively weak against radial compression.

The shell internal structure incorporates features to enhance leachability. The shell internal structure may include at least one internal passageway. The shell internal structure may be conditioned to control heat transfer in the shell.

The shell may include at least one channel, and the method may further include repeatedly exposing the surface of the photosensitive medium to light from the light source to build the shell including the at least one channel.

The method may further include repeatedly exposing the surface of the photosensitive medium to light from the light source to build the shell such that the shell internal structure is substantially porous.

The shell may further include an outer surface, the shell internal structure being deposed between the inner surface and the outer surface. The method may further include applying a reinforcement material to the outer surface. The outer surface may include one or more attachment points. The method may further include wrapping a wrapping agent around the shell.

The method may further include: receiving a cast design; determining a desired attachment point for the shell; and modifying the cast design to include the desired attachment point. The method may further include: receiving a cast design; determining a desired shell internal structure for the shell; and modifying the cast design to include the desired shell internal structure. The method may further include repeatedly exposing the surface of the photosensitive medium to light from the light source to build the cast in accordance with the modified cast design.

The cast may further include a core. The core may include a surface and a core internal structure, and the method may further include repeatedly exposing the surface of the photosensitive medium to light from the light source to build the cast including the core internal structure.

The core internal structure may include at least one of sub-millimeter interior features and micro-architecture features. The core internal structure may include at least one of a lattice, a truss, and at least one tube. The core internal structure may be conditioned to control heat transfer in the core. The core internal structure may be rigid against flexure and axial compression by weak against radial compression. The core may be selectively weak against radial compression.

The core internal structure may include features to enhance leachability of the core. The core internal structure may include at least one internal passageway. The core may include at least one channel. The core internal structure may be substantially porous.

The method may further include: receiving a cast design; determining a desired core internal structure for the core; modifying the cast design to include the desired core internal structure; and repeatedly exposing the surface of the photosensitive medium to light from the light source to build the cast in accordance with the modified cast design.

The method may further include depositing one or more secondary substances across a build surface. The one or more secondary substances are deposited by a depositor. The depositor may include at least one of an articulating arm, an inkjet printer configured to print the secondary substances across the build surface, an XY scanning stage, and an XY scanning track. The one or more secondary substances may include at least one from among a photoinhibitor, a photoinitiator, a monomer, and one or more secondary photopolymerizable suspensions, the one or more secondary photopolymerizable suspensions being distinct from the photosensitive medium. The photoinhibitor may include a light absorbing dye.

The method may further include selectively depositing a photoinhibitor to limit curing of the photosensitive medium beneath the photoinhibitor. The method may further include selectively depositing a photoinhibitor around an edge of a current layer being built. The method may further include selectively depositing a photoinitiator to locally increase photocuring reactivity of the photosensitive medium beneath the photoinitiator. The method may further include depositing one or more secondary photopolymerizable suspensions to provide a multi-layered object when cured. The method may further include selectively depositing the one or more secondary photopolymerizable suspensions across the build surface following application of a current layer of the photosensitive medium, but prior to curing the current layer of the photosensitive medium. The method may further include selectively depositing the one or more secondary photopolymerizable suspensions across the build surface following curing a previous layer of the photosensitive medium, but prior to application of the current layer of the photosensitive medium.

The method may further include: determining at least one photosensitive medium and curing property; modifying an image slice based on the at least one photosensitive medium and curing property; and exposing the surface of the photosensitive medium to light from the light source based on the modified image slice.

The method may further include: determining at least one photosensitive medium and curing property; and modifying an intensity of the light source based on the at least one photosensitive medium and curing property.

The photosensitive medium and curing property may include at least one from among light scattering, side scattering, shrinkage, print-through, curing expansions, polymerization shrinkage, sintering shrinkage, broadening behavior of a suspension of the photosensitive medium, optical properties of the suspension medium, absorption coefficient of the suspension medium, refractive index of the suspension medium, optical properties of powders in the suspension, absorption of the powders in the suspension, refractive index of the powders in the suspension, powder particle size distribution, changes due to subsequent processing and/or heat treatment.

Modifying the image slice may include at least one of making positive and/or negative boundary corrections of the image slice and inserting a keyhole for a corner of the image slice.

Determining the at least one photosensitive medium and curing property may include performing physics-based simulations to estimate the at least one photosensitive medium and curing property. Determining the at least one photosensitive medium and curing property may include retrieving stored information about the at least one photosensitive medium and curing property.

The method may further include exposing the surface of the photosensitive medium to light from the light source based on the modified image slice in accordance with one or more a calibration images to form one or more test layers. The method may further include capturing a geometry of the one or more test layers. The method may further include comparing the captured geometry of the one or more test layers to the one or more calibration images to determine the at least one photosensitive medium and curing property. The method may further include: capturing a geometry of one or more cured layers; comparing the captured geometry of the one or more cured layers to an intended geometry of the one or more cured layers; and determining the at least one photosensitive medium and curing property based on the comparison. The geometry may be captured using at least one from among a camera, an infrared sensor, a laser grid emitter, and a three-dimensional (3D) scanner.

According to some embodiments, there is provided a cast including: a shell; and a part void. The shell may be selectively weak against radial compression. The shell may include at least one channel.

The shell may include an inner surface and a shell internal structure. The shell internal structure may include at least one of sub-millimeter interior features and micro-architecture features. The shell internal structure may include at least one of a lattice, a truss, or a tube. The shell internal structure may be rigid against flexure and axial compression by weak against radial compression. The shell internal structure may incorporate features to enhance leachability. The shell internal structure may include at least one internal passageway. The shell internal structure may be conditioned to control heat transfer in the shell. The shell internal structure may be substantially porous.

The shell may further include an outer surface, the shell internal structure being deposed between the inner surface and the outer surface. The outer surface may include one or more attachment points.

The cast may further include a core disposed within the part void. The core may be selectively weak against radial compression. The core may include at least one channel.

The core may include a surface and a core internal structure. The core internal structure may include at least one of sub-millimeter interior features and micro-architecture features. The core internal structure may include at least one of a lattice, a truss, and at least one tube. The core internal structure may be conditioned to control heat transfer in the core. The core internal structure may be rigid against flexure and axial compression by weak against radial compression. The core internal structure may include features to enhance leachability of the core. The core internal structure may include at least one internal passageway. The core internal structure may be substantially porous.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed devices, systems, and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

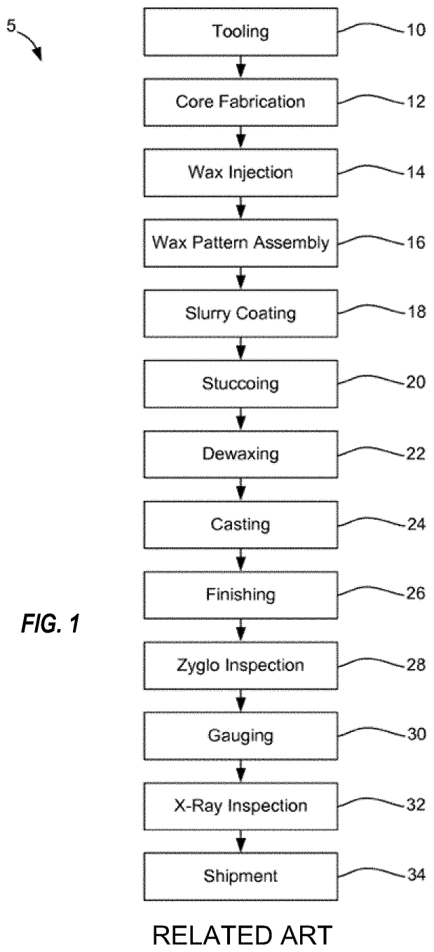

FIG. 1 is a flowchart 5 for conventional investment casting of three-dimensional objects according. For example, the flowchart 5 illustrated in FIG. 1 could be utilized to create turbine airfoils; turbine airfoils with extremely complex interior cooling passages are often produced by investment casting. The process of FIG. 1 begins with the creation of all the tooling 10 necessary to fabricate the cores, patterns, mold, and setters for casting the items, typically involving over a thousand tools for each item. The next step involves fabrication 12 of ceramic cores by injection molding. Molten wax may also be injection molded 14 to define the patterns for the object's shape. Several such wax patterns are then assembled 16 into a wax pattern assembly or tree. The pattern assembly is then subjected to multiple rounds of slurry coating 18 and stuccoing 20 to form the completed mold assembly. The mold assembly is then placed in an autoclave for dewaxing 22. The result is a hollow ceramic shell mold into which molten metal in poured to form the castings 24. Upon solidification, the ceramic mold is broken away and the individual metal castings are separated therefrom. The castings are next finished 26, 28, 30 and inspected 32 prior to shipment 34.

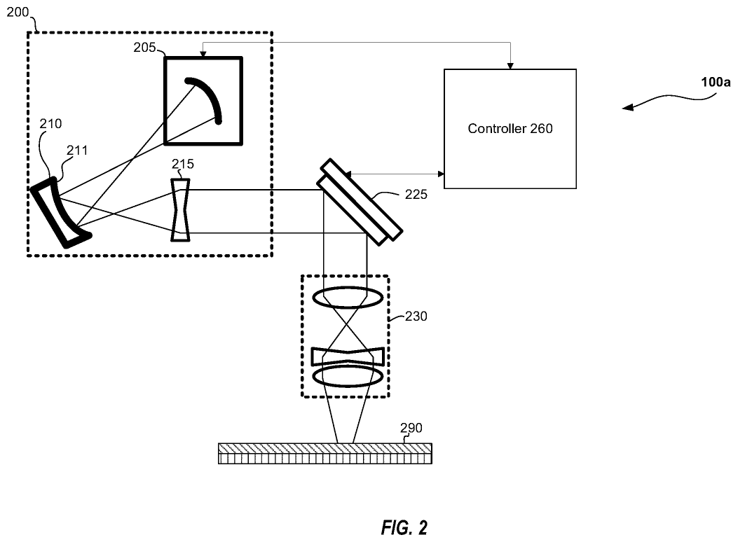

FIG. 2 illustrates a plan view of an example 3D printing system. The 3D printing system 100a for fabricating a three-dimensional object includes the optical imaging system 200. The optical imaging system 200 or radiation system includes a light source 205, a reflector system 210, an optical lens system 215, a mirror 225 (e.g., a digital micromirror device (DMD)), and a projection lens 230. The light source 205 may illuminate, and thus provide a light. Various embodiments of the present invention may include light sources including any one of an ultraviolet light, violet light, blue light, green light, actinic light, and the like. In an exemplary embodiment, the light source has a particular, predetermined wavelength in the UV spectrum. Embodiments of the present invention may be described herein as a UV light source, but embodiments of the present invention are not limited to such a light source, and other light sources, including the examples disclosed may be implemented.

The light emitting from the light source 205 may be projected upon a portion of the reflector system 210, and reflects from the reflector system 210, which may include a concave-shaped reflector 211. The reflector 211 of the reflector system 210 directs the light through a lens 216 of the optical lens system 215 before it reaches the DMD 225. The light from the DMD 225 is next directed towards the projection lens 230. The light from the projection lens 230 is then projected onto the surface 290 of the photosensitive medium. The light source 205 and DMD 225 may be controlled by a controller 260 (e.g., hardware and/or software configured to control the 3D printing system). Controller 260 may dynamically control the DMD 225 and the light source 205 to customize a 3D printed item. In some cases, the light source 205 and DMD 225 may provide feedback to the controller 260.

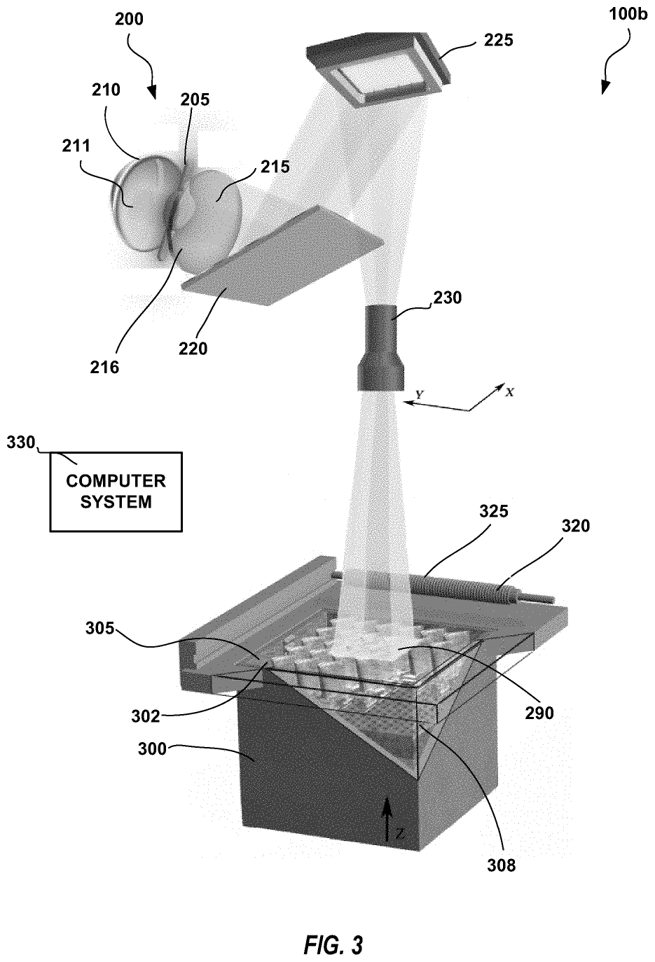

FIG. 3 illustrates a perspective view of an example embodiment of 3D printing system 100b including the optical imaging system 200 emitting a light source onto a given surface 290 of the photosensitive medium. 3D printing system 100b may be thought of as illustrating a schematic view of an SLM-based CtCP scanning maskless imaging system.

In an embodiment, the light source 205 (e.g., UV light source 205) may be a mercury vapor lamp, xenon lamp, violet laser diode, diode pumped solid state laser, frequency-tripled Nd:YAG laser, XeF excimer laser, or the like. The UV light source 205 may illuminate an SLM 225 or an array of SLMs 225, e.g., one by two, such that the beams reflected from the ON pixels of the SLM 225 array are coupled into the projection lens while the beams from the OFF pixels are directed away from the lens. The elements of the SLM 225, e.g., a DMD, 225, may be individually controllable by the data (e.g., CAD data) from a computer (e.g., computer system 330), enabling rapid, programmable selection of a large number of sites for laser irradiation. In some cases, the elements of SLM 225 may be approximately 15 micrometers (μm) square in size. The DMD 225 may modulate the illumination by means of its bi-stable mirror configuration, which, in the ON state, directs reflected illumination toward a projection lens, and in the OFF state, directs illumination away from the lens.

Light emitted from light source 205 may be projected upon a portion of the reflector system 210, and reflect from the reflector system 210, which may include a concave- shaped reflector 211. Light from the reflector system 210 may be directed through a lens 216 of the optical lens system 215. The light may then reflect off of secondary mirror 220, before reaching SLM 225. The light from the SLM 225 is next directed towards the projection lens 230. The light from the projection lens 230 is then projected onto the surface 290 of the photosensitive medium.

The entire optical imaging system 200 may be mounted on an XY scanning stage with a large area of travel spanning, for example, several hundred millimeters. As the optical imaging system 200 is scanned over different areas of the medium, e.g., the substrate 290, the projection lens 230, with the appropriate magnification or reduction, images the ON pixels of the SLM array directly onto the substrate 290.

The photo sensitive medium may be disposed in material build platform (MBP) 300. The MBP 300 may include a container 305 that serves as the build volume 302. The MBP 300 may incorporate a build substrate mounted on a high-accuracy z-translation stage 308 for building an object in layers e.g., approximately 25 micrometer (and larger) thicknesses using the photosensitive medium. Thinner layers of the photosensitive medium may be created when the dimensions of a feature of the three-dimensional object require so. Similarly, when the dimensions of a feature of the three-dimensional object are large, thicker layers of the photosensitive medium may be used. As an example, he overall dimensions of the overall build volume 302 may be approximately 24 inches (X) by 24 inches (Y) by 16 inches (Z) (24″×24″×16″). A build surface of stage 308 may be made of a precision machined plate and may be located within the build volume 302 (i.e., in the MBP's interior) and may be mounted on a precision linear motion stage for motion in the Z-direction. During the fabrication of a part, the build surface may be moved incrementally downwards by a distance equal to the layer thickness with which the part is being built. The control system 330 may control this downward movement.

Material recoating system (MRS) 320 deposits uniform (or near uniform) thickness layers of the photosensitive medium across the interior of the material build platform 300 (e.g., under the control of computer system 330), without disturbing the previously built layers. Once a new layer of the photosensitive medium has been formed, focusing and alignment optics may ensure that the surface of the medium is at the focal plane of the projection lens, making fine adjustments in the Z-direction if necessary. Upon completion of this step, the LAMP process repeats the cycle of building the next layer and delivering new resin until the entire build is completed.

The MRS 320 may include a coating device 325, which may be, without limitation, a wire-wound Mayer draw-down bar, a comma bar, or a knife edge or a slurry dispensing system. The MRS 320 may incorporate a coating device capable of applying coatings as thin as approximately 2.5 microns with 0.25 micron variation or thinner (depending on the medium and/or various configurations). The MRS 320 may be designed to successively deposit the layers of the photosensitive medium. During a part build, upon the completion of a layer exposure, the MRS 320 may quickly sweep the medium across the build area under computer system 330 control. The MRS 320 may implement principles from the web-coating industry, where extremely thin and uniform coatings (on the order of a few micrometers) of various particulate-loaded formulations are deposited on fixed, flat, or flexible substrates.

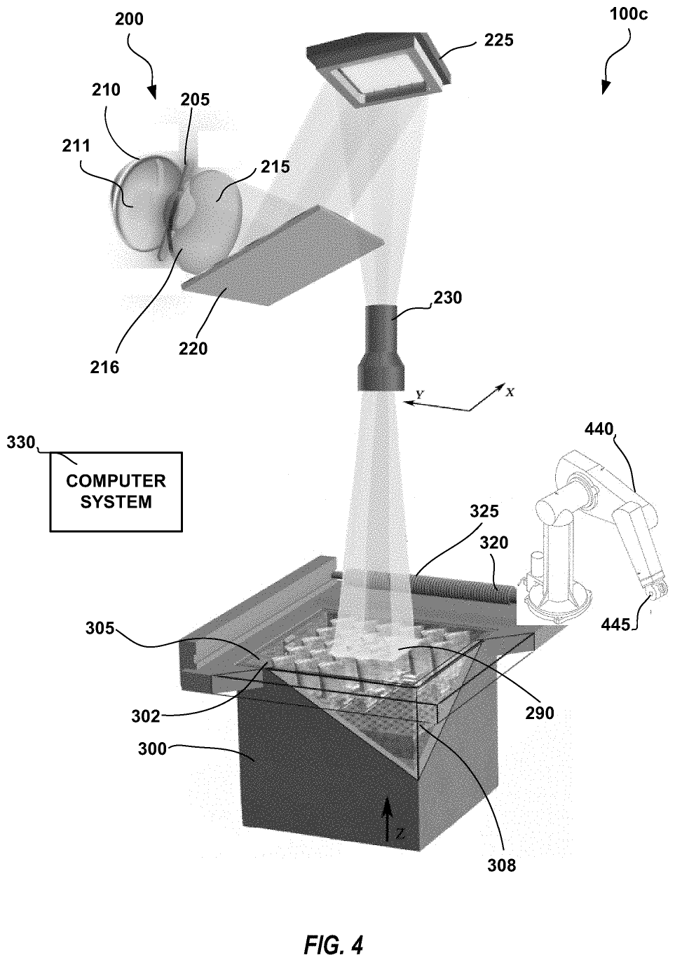

FIG. 4 illustrates a perspective view of an example embodiment of 3D printing system 100c including the optical imaging system 200 emitting a light source onto a given surface 290 of the photosensitive medium. FIG. 4 is substantially similar to FIG. 3, except 3D printing system 100c of FIG. 4 further includes a depositor 440.

In an embodiment, the light source 205 (e.g., UV light source 205) may be a mercury vapor lamp, xenon lamp, violet laser diode, diode pumped solid state laser, frequency-tripled Nd:YAG laser, XeF excimer laser, or the like. The UV light source 205 may illuminate an SLM 225 or an array of SLMs 225, e.g., one by two, such that the beams reflected from the ON pixels of the SLM 225 array are coupled into the projection lens while the beams from the OFF pixels are directed away from the lens. The elements of the SLM 225, e.g., a DMD, 225, may be individually controllable by the data (e.g., CAD data) from a computer (e.g., computer system 330), enabling rapid, programmable selection of a large number of sites for laser irradiation. In some cases, the elements of SLM 225 may be approximately 15 micrometers (μm) square in size. The DMD 225 may modulate the illumination by means of its bi-stable mirror configuration, which, in the ON state, directs reflected illumination toward a projection lens, and in the OFF state, directs illumination away from the lens.

Light emitted from light source 205 may be projected upon a portion of the reflector system 210, and reflect from the reflector system 210, which may include a concave-shaped reflector 211. Light from the reflector system 210 may be directed through a lens 216 of the optical lens system 215. The light may then reflect off of secondary mirror 220, before reaching SLM 225. The light from the SLM 225 is next directed towards the projection lens 230. The light from the projection lens 230 is then projected onto the surface 290 of the photosensitive medium.

The entire optical imaging system 200 may be mounted on an XY scanning stage with a large area of travel spanning, for example, several hundred millimeters. As the optical imaging system 200 is scanned over different areas of the medium, e.g., the substrate 290, the projection lens 230, with the appropriate magnification or reduction, images the ON pixels of the SLM array directly onto the substrate 290.

The photo sensitive medium may be disposed in material build platform (MBP) 300. The MBP 300 may include a container 305 that serves as the build volume 302. The MBP 300 may incorporate a build substrate mounted on a high-accuracy z-translation stage 308 for building an object in layers e.g., approximately 25 micrometer (and larger) thicknesses using the photosensitive medium. Thinner layers of the photosensitive medium may be created when the dimensions of a feature of the three-dimensional object require so. Similarly, when the dimensions of a feature of the three-dimensional object are large, thicker layers of the photosensitive medium may be used. As an example, he overall dimensions of the overall build volume 302 may be approximately 24 inches (X) by 24 inches (Y) by 16 inches (Z) (24″×24″×16″). A build surface of stage 308 may be made of a precision machined plate and may be located within the build volume 302 (i.e., in the MBP's interior) and may be mounted on a precision linear motion stage for motion in the Z-direction. During the fabrication of a part, the build surface may be moved incrementally downwards by a distance equal to the layer thickness with which the part is being built. The control system 330 may control this downward movement.

Material recoating system (MRS) 320 deposits uniform (or near uniform) thickness layers of the photosensitive medium across the interior of the material build platform 300 (e.g., under the control of computer system 330), without disturbing the previously built layers. Once a new layer of the photosensitive medium has been formed, focusing and alignment optics may ensure that the surface of the medium is at the focal plane of the projection lens, making fine adjustments in the Z-direction if necessary. Upon completion of this step, the LAMP process repeats the cycle of building the next layer and delivering new resin until the entire build is completed.

The MRS 320 may include a coating device 325, which may be, without limitation, a wire-wound Mayer draw-down bar, a comma bar, or a knife edge or a slurry dispensing system. The MRS 320 may incorporate a coating device capable of applying coatings as thin as approximately 2.5 microns with 0.25 micron variation or thinner (depending on the medium and/or various configurations). The MRS 320 may be designed to successively deposit the layers of the photosensitive medium.

When a layer of slurry is dispensed by MRS 320, depositor 440 may deposit non-reactive materials onto select portions of the surface. The material may include a photoinhibitor (e.g., an absorbing dye), such as an ink, to limit and/or prevent solidification of underlying slurry caused by exposure to the light source. The material may include a photoinitiator to locally increase the curing capacity and/or depth of the light from the light source. However, this is merely an example. Depositor may deposit the material utilizing a nozzle 445. Although depositor 440 is depicted as an articulating arm, this is merely an example. In some cases, depositor 440 may be mounted on an XY scanning stage and/or tracks with a large area of travel spanning, for example, an entirety of surface 290. Furthermore, although depositor 440 is described as depositing material after MRS 330 applies a coat of slurry, this is merely an example. In some cases, depositor 440 may deposit material (e.g., dye) prior to the coating, for example, on an edge of a receding surface.

According to some implementations, depositor 440 may deposit a second photopolymerizable suspension instead of (or in addition to) applying an absorber and/or photoinitiator. For example, depositor 440 may spray or inkjet print one or more layers of a second photopolymerizable suspension onto the surface of the previously swept layer. The newly applied second photopolymerizable suspension can remain as distinct surface layer(s) and, upon photopolymerization, can provide a bi-layer or heterogeneously layered product. Such multi-layered products can provide additional benefits over homogenous products. In some cases, multiple layers of a photopolymerizable suspension can be spray coated or inkjet printed prior to photopolymerization to achieve a desired build layer thickness. Each layer can have a distinct uniform composition. Additionally, within each layer (e.g., within each cured layer), there can be in-plane variations of composition.

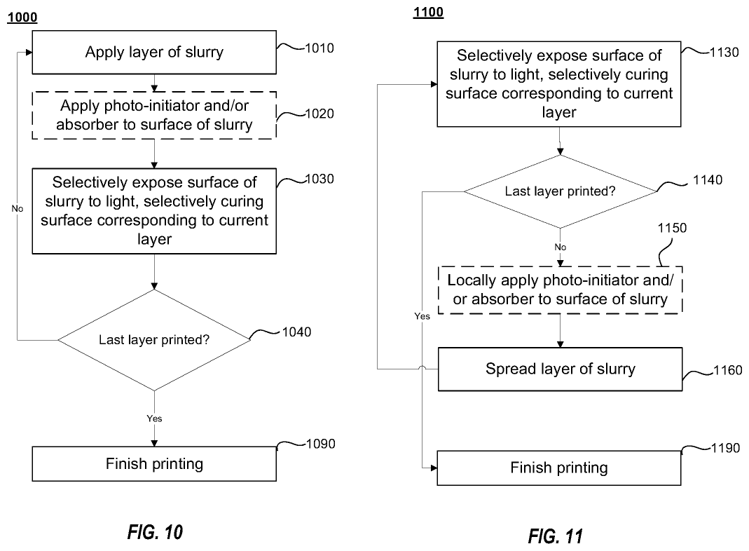

Example functionalities and/or uses of depositor 440 will be discussed below in greater detail with reference to FIGS. 10-13.

During a part build, upon the completion of a layer exposure, the MRS 320 may quickly sweep the medium across the build area under computer system 330 control. The MRS 320 may implement principles from the web-coating industry, where extremely thin and uniform coatings (on the order of a few micrometers) of various particulate-loaded formulations are deposited on fixed, flat, or flexible substrates.

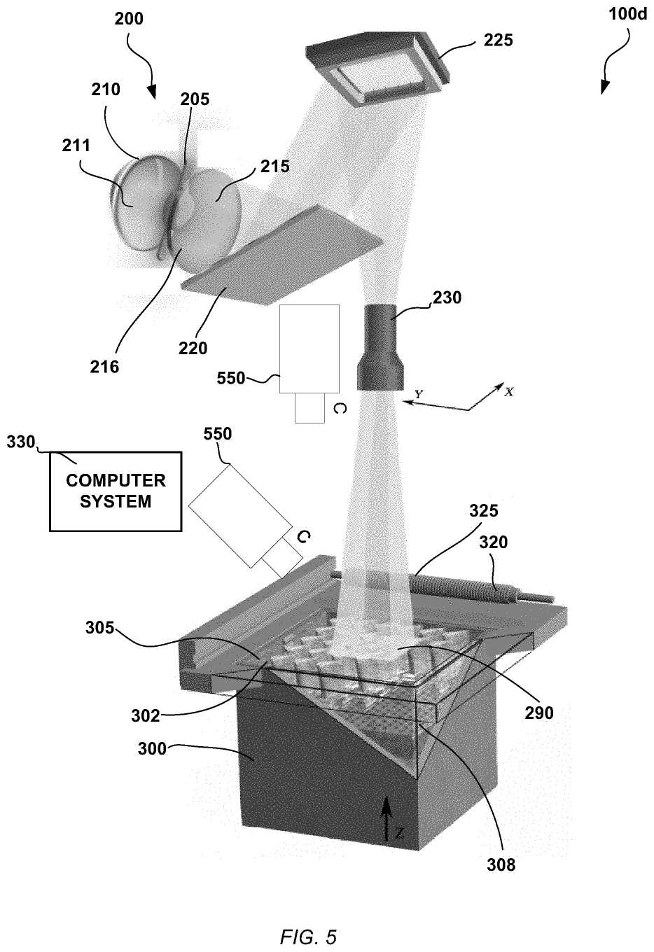

FIG. 5 illustrates a perspective view of an example embodiment of 3D printing system 100d including the optical imaging system 200 emitting a light source onto a given surface 290 of the photosensitive medium. FIG. 5 is substantially similar to FIG. 3, except 3D printing system 100d of FIG. 4 further includes one or more image capturing devices (e.g., cameras) 550.

In an embodiment, the light source 205 (e.g., UV light source 205) may be a mercury vapor lamp, xenon lamp, violet laser diode, diode pumped solid state laser, frequency-tripled Nd:YAG laser, XeF excimer laser, or the like. The UV light source 205 may illuminate an SLM 225 or an array of SLMs 225, e.g., one by two, such that the beams reflected from the ON pixels of the SLM 225 array are coupled into the projection lens while the beams from the OFF pixels are directed away from the lens. The elements of the SLM 225, e.g., a DMD, 225, may be individually controllable by the data (e.g., CAD data) from a computer (e.g., computer system 330), enabling rapid, programmable selection of a large number of sites for laser irradiation. In some cases, the elements of SLM 225 may be approximately 15 micrometers (μm) square in size. The DMD 225 may modulate the illumination by means of its bi-stable mirror configuration, which, in the ON state, directs reflected illumination toward a projection lens, and in the OFF state, directs illumination away from the lens.

Light emitted from light source 205 may be projected upon a portion of the reflector system 210, and reflect from the reflector system 210, which may include a concave- shaped reflector 211. Light from the reflector system 210 may be directed through a lens 216 of the optical lens system 215. The light may then reflect off of secondary mirror 220, before reaching SLM 225. The light from the SLM 225 is next directed towards the projection lens 230. The light from the projection lens 230 is then projected onto the surface 290 of the photosensitive medium.

The entire optical imaging system 200 may be mounted on an XY scanning stage with a large area of travel spanning, for example, several hundred millimeters. As the optical imaging system 200 is scanned over different areas of the medium, e.g., the substrate 290, the projection lens 230, with the appropriate magnification or reduction, images the ON pixels of the SLM array directly onto the substrate 290.

The photo sensitive medium may be disposed in material build platform (MBP) 300. The MBP 300 may include a container 305 that serves as the build volume 302. The MBP 300 may incorporate a build substrate mounted on a high-accuracy z-translation stage 308 for building an object in layers e.g., approximately 25 micrometer (and larger) thicknesses using the photosensitive medium. Thinner layers of the photosensitive medium may be created when the dimensions of a feature of the three-dimensional object require so. Similarly, when the dimensions of a feature of the three-dimensional object are large, thicker layers of the photosensitive medium may be used. As an example, he overall dimensions of the overall build volume 302 may be approximately 24 inches (X) by 24 inches (Y) by 16 inches (Z) (24″×24″×16″). A build surface of stage 308 may be made of a precision machined plate and may be located within the build volume 302 (i.e., in the MBP's interior) and may be mounted on a precision linear motion stage for motion in the Z-direction. During the fabrication of a part, the build surface may be moved incrementally downwards by a distance equal to the layer thickness with which the part is being built. The control system 330 may control this downward movement.

Material recoating system (MRS) 320 deposits uniform (or near uniform) thickness layers of the photosensitive medium across the interior of the material build platform 300 (e.g., under the control of computer system 330), without disturbing the previously built layers. Once a new layer of the photosensitive medium has been formed, focusing and alignment optics may ensure that the surface of the medium is at the focal plane of the projection lens, making fine adjustments in the Z-direction if necessary. Upon completion of this step, the LAMP process repeats the cycle of building the next layer and delivering new resin until the entire build is completed.

The MRS 320 may include a coating device 325, which may be, without limitation, a wire-wound Mayer draw-down bar, a comma bar, or a knife edge or a slurry dispensing system. The MRS 320 may incorporate a coating device capable of applying coatings as thin as approximately 2.5 microns with 0.25 micron variation or thinner (depending on the medium and/or various configurations). The MRS 320 may be designed to successively deposit the layers of the photosensitive medium. During a part build, upon the completion of a layer exposure, the MRS 320 may quickly sweep the medium across the build area under computer system 330 control. The MRS 320 may implement principles from the web-coating industry, where extremely thin and uniform coatings (on the order of a few micrometers) of various particulate-loaded formulations are deposited on fixed, flat, or flexible substrates.

Image capturing devices 550 may capture image data and/or dimensions of a solidified layer. For example, 3D printing system 100 of FIG. 4 may build a test structure to determine characteristics or properties of the slurry (e.g., light scattering, light penetration, slurry shrinkage upon solidification, and/or slurry growth upon solidification). Image capturing devices 500 may capture image data of a layer generated from a testing program (e.g., executed according to computer system 330), and computer system 330 may determine material properties of the slurry. Based thereon, computer system 330 may alter an image slice and/or light characteristics for projection. Image capturing device(s) 550 may include, as non-limiting examples, an infrared sensor, a laser grid emitter, or the like.

In some implementations, image capturing device(s) 550 may capture images of printed layers, and computer system 330 may determine and/or monitor slurry characteristics over time. Based thereon, computer system 330 may alter an image slice and/or light characteristics for projection.

As will be understood by one of ordinary skill, in some cases, image capturing devices 550 may be used in conjunction with depositor 440, either separately or to improve depositor's 440 placement of the select material. Example functionalities and/or uses of image capturing devices 550 will be discussed below in greater detail with reference to FIGS. 10 and 11.

Unless explicitly stated otherwise or impossible by virtue of specific requirements, each of 3D printing system 100 of FIGS. 2-4 may be used to generate various casts and/or structures including various internal structures and anchoring points as described herein, as will be understood by one of ordinary skill in light of the present disclosure.

### Cast Architecture

Certain castings require hollow and/or concave structures. To form such structures, a cast must have a core. As the metal solidifies, it undergoes volumetric shrinkage and contracts around the core. The core must be sufficiently rigid to remain solid during metal poring, but must be weak enough such that, when the metal shrinks, it is compressed or crushed by the cooling metal. If the core is overly rigid, casting defects may occur, for example, hot tears, recrystallization, and other defects. Furthermore, after solidification is complete, the remnants of the core may need to be removed. Traditionally, this is accomplished by water blasting or leached out with a caustic solution (e.g., caustic leaching). Aspects of the present disclosure improve upon these aspects of the traditional casting.

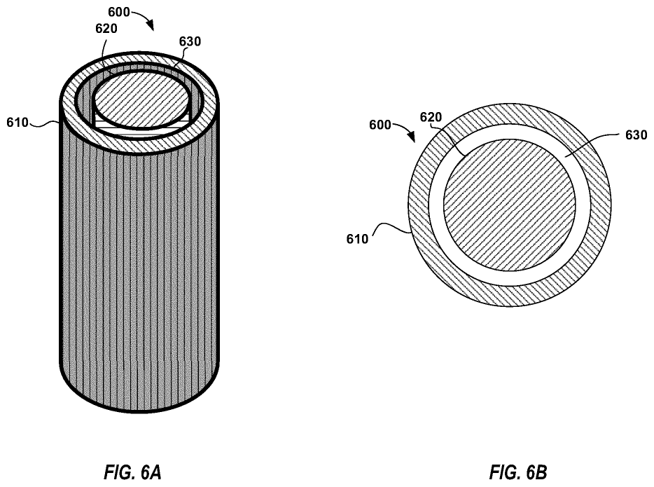

FIG. 6A and 6B provide perspective and top views of a cast 600 according to an example embodiment. Cast 600 includes a shell 610 and a core 620. Between shell 610 and core 620 is a part volume 630. During casting, hot metal will be fill the part volume 630, for example, by be gravity pouring, applying positive air pressure, vacuum casting, tilt casting, pressure assisted pouring, centrifugal casting or the like. As the metal cools it contracts and provides pressure against core 620 and, to some extent, shell 610. Once the metal contracts to a certain point, core 610 is at least partially crushed, thereby preventing the metal from hot tearing.

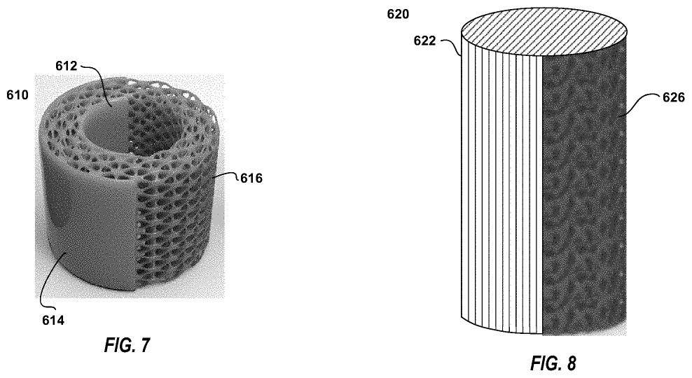

In some embodiments, shell 610 and/or core 620 may include internal structures, such as sub-millimeter interior features and/or micro-architecture. For example, as illustrated in FIG. 7, shell 610 includes an internal surface 612 and an internal structure 616. As depicted in FIG. 7, the internal structure 616 is a lattice or truss. As will be understood by one of ordinary skill in light of the present disclosure, internal structure 616 may have various lattice forms and/or patterns to provide predetermined mechanical properties. For example, shell 610 must be strong/rigid enough to withstand pouring, but weak enough to crush upon metal cooling.

In some cases, shell 610 may have a plurality of internal structures configured to break (e.g., be crushed) by contraction of the cooling metal at predetermined points. In certain embodiments, shell 610 further includes outside surface 614, e.g., a sandwich structure or sandwiched honey comb structure. In certain embodiments, an anchoring structure may be provided external to internal structure 616. For example, a 3D printed shell may be covered in stucco (e.g., dipped, or sprayed) and covered in sand to create thicker shell 610 walls. In some instances, a wrapping agent (e.g., ceramic wool or cloth) may be wrapped around cast shell 610. The anchoring points may be used to enhance shell 610 “grab” of the wrap.

Further, in some embodiments, internal structure 616 may incorporate features (e.g., micro-architectural features) to enhance leachability. For example, internal structure 616 may facilitate the entry of leaching solution by means of internal passageways (e.g., channels). To this end, in some embodiments, shell 610 can be designed with a porous interior structure that can expose a significantly greater reactive surface area of shell 610 to the leaching agent than a solid shell 610 to facilitate fast dissolution. Similarly, an internal structure 616, such as internal passageways or lattice structures, may make shell 610 more easily removed by water blasting, for example, by providing additional surface area for contact with the blasted water, and/or providing structured conducive to breaking up upon water blasting.

In some instances, post 3D printing, inner surface 612 may be coated with an additional substance. For example, shell 610 may be dip infiltrated so that inner surface 612 is coated with a different material. For example, inner surface 612 may be coated or infiltrated with a reinforcement material or separate ceramic material to encourage specific micro-structures of a casted part. For example, certain ceramic materials, such as cobalt aluminate, encourages specific crystal structures (e.g., poly-crystal structures) to be formed by the cast material. In some embodiments, face coats such as yttrium oxide (yttria) and silicates may coat inner surface 612.

As illustrated in FIG. 8, core 620 includes surface 622 and an internal structure 626. As depicted in FIG. 8, the internal structure 626 is a lattice or truss. As will be understood by one of ordinary skill in light of the present disclosure, internal structure 626 may have various lattice forms and/or patterns to provide predetermined mechanical properties. For example, core 620 must be strong/rigid enough to withstand pouring, but weak enough to crush upon metal cooling.

In some cases, core 620 may have a plurality of internal structures configured to break (e.g., be crushed) by contraction of the cooling metal at predetermined points. In certain embodiments, internal structure 626 may be configured to fail (e.g., “be crushed”) substantially uniformly.

Further, in some embodiments, internal structure 626 may incorporate features (e.g., micro-architectural features) to enhance leachability. For example, internal structure 626 may facilitate the entry of leaching solution by means of internal passageways (e.g., channels). To this end, in some embodiments, core 620 can be designed with a porous interior that can expose a significantly greater reactive surface area of core 620 than a solid core 620 to facilitate fast dissolution. Similarly, an internal structure 626, such as internal passageways or lattice structures, may make core 620 more easily removed by water blasting, for example, by providing additional surface area for contact with the blasted water, and/or providing structured conducive to breaking up upon water blasting.

In some instances, post 3D printing, surface 622 may be coated with an additional substance. For example, core 620 may be dip infiltrated so that surface 622 is coated with a different material. For example, surface 622 may be coated or infiltrated with a reinforcement material or separate ceramic material to encourage specific micro-structures of a casted part. For example, certain ceramic materials, such as cobalt aluminate, encourages specific crystal structures (e.g., nuclearization or poly-crystal structures) to be formed by the metal upon cooling. In some embodiments, face coats such as yttrium oxide (yttria) and silicates may coat surface 622.

In some embodiments, the design of the micro-architecture of internal structure 616 and/or internal structure 626 promote torsional and flexural rigidity of the shell 610 and core 620, while keeping the ceramic core 620 fragile to compression forces. Further, in some embodiments, the micro-architecture ceramic cores can incorporate features to enhance leachability. In some embodiments, leachability can be enhanced by internal architecture designs which facilitate the entry of leaching solution by means of internal passageways. To this end, in some embodiments, cores can be designed with a porous interior that can expose a significantly greater reactive surface area than solid cores to facilitate fast dissolution.

In some embodiments, internal structure 616 and/or internal structure 626 may be, in part, topologically tubes. As will be understood by one of ordinary skill in light of the present disclosure, tubular designs can be rigid against flexure and axial compression, but weak against radial compression. A simple hollow tube it resists bending and axial compression, but is weak to radial compression. In some embodiments, internal struts can be provided within internal structure 616 and/or internal structure 626 to locally strengthen shell 610 and/or core 620 in desired areas. In this manner, a designed pattern of crushing can be created.

In some embodiments, custom-designed internal microarchitecture within internal structure 616 and/or internal structure 626 can be used to control the heat transfer in the shell 160/core 620 during casting. In this way, the internal microarchitecture can be used to enable local control of metal solidification through the design of temperature gradients. In some embodiments, this approach can be used to locally control the crystal structure in the solidified metal with the aid of predictive solidification and microstructure evolution models (e.g., as executed by computer system 330). In this way, recrystallization of the solidifying metal can be avoided, which is a known problem.

In some embodiments, microarchitecture in cores 620 and/or shell 610 may include vascular channels that can enable backfilling of the channel with a second material to manufacture a dual-phase core.

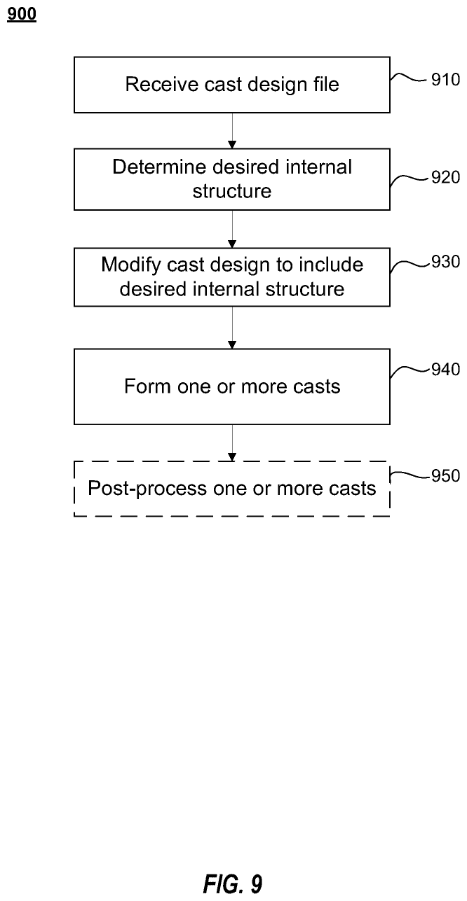

FIG. 9 is a flow chart 900 of a method of forming a cast 600 (or mold) according to an example embodiment. The method may be performed, for example, by 3D printing system 100 of any of FIGS. 2-4. The method includes receiving 910 (e.g., by computer system 330) a cast design file. For example, cast design file 910 may include a blueprint and/or CAD instructions for forming a desired cast 600. The cast 600 includes a shell (e.g., shell 610). In some cases, the cast 600 may include a core (e.g., core 620). Computer system 330 may determine 920 desired internal structures (e.g., internal structure 616/626 of core 610/shell 620). For example, computer system 330 may identify portion of internal structure 616/626 that should include lattice structure, topological tubes, and/or channels. Computer system 330 may modify 930 the cast design to include the desired internal structure. Based on the modified cast design, 3D printing system 100 may form 940 one or more corresponding casts 600 (e.g., using Large Area Maskless Photopolymerization (LAMP)). For example, as will be understood by one of ordinary skill, computer system 330 may extract a plurality of slices of the modified design file, and control 3D printing system 100 to repeatedly expose layers of the slurry to light patterns corresponding to the slice cast design.

Once formed, one or more post-processes may be performed on the casts 600. For instance, in some cases, an outside surface of cast 600 may include one or more attachment points. In certain embodiments, an anchoring structure may be provided external to internal structure 616. A wrapping agent (e.g., ceramic wool or cloth) may be wrapped around cast shell 610. In some cases, cast 600 may be covered in stucco (e.g., dipped, or sprayed) and covered in sand to create thicker shell 610 walls. In certain cases, shell 610 may be dip infiltrated so that inner surface 612 is coated with a different material. For example, inner surface 612 and/or surface 622 may be coated or infiltrated with a reinforcement material or separate ceramic material to encourage specific micro-structures of a casted part. For example, certain ceramic materials, such as cobalt aluminate, encourages specific crystal structures (e.g., poly-crystal structures) to be formed by the cast material. In some embodiments, face coats such as yttrium oxide (yttria) and silicates may coat inner surface 612 and/or surface 622.

### Layer Modification

In additive manufacturing via photopolymerization (e.g., Large Area Maskless Photopolymerization (LAMP)), a photocurable suspension (e.g., surface 290) can be exposed to radiation from a light source 200 to cure the suspension into a solid or semi-solid state. The composition of the photocurable suspension can include one or more monomers, photoinitiators, and/or absorbers. Compositions can further include one or more types of filler particles, and can include other additives to control the dispersion of the particles and the rheology of the liquid suspension. The cure characteristics of the photopolymerizable suspension can be governed by the amounts of photoinitiators and/or absorbers generally present in the suspension (when homogenous) or locally present in the suspension (when heterogenous). These cure characteristics are typically measured through the critical energy dose E_{c} and the sensitivity Dₚ. The critical energy dose E_{c} defines the minimum energy dose (e.g., light intensity from light source 200) required to initiate gelation (e.g., curing) of the slurry, while the sensitivity Dₚ defines the penetration depth of the suspension (e.g., the depth at which the incident light intensity drops to 1/e² of its surface value).

E_{c} and Dₚ govern the thickness of cured suspension or cure depth C_{d} as a function of the light 200 energy dose delivered to the surface 290 of the suspension. The cure depth increases with increasing energy dose; thus, the energy dose can be tuned to achieve a desired cure depth, which may be chosen based on desired layer thickness for a given layer of the object being built using additive manufacturing. Often, the sensitivity Dₚ is higher than desired, such that the cure depth C_{d} may be significantly greater than defined by a given slice (e.g., layer). This helps ensure that the layer-to-layer bonding is sufficiently strong that the layers do not suffer delamination during or after the build.

However, a high sensitivity Dₚ and a high cure depth C_{d} have the negative unintended consequence of light penetrating too deep into previously formed underlying layers. Thus, features of underlying channels, such as holes and channels may get “blurred” or printed through when light passes through higher layers and cross-links the photopolymerizable suspension in regions where there should be no curing. Print-through can cause loss of resolution and leads to the inability to form features present in the design intent geometry (e.g., design file), even when the native resolution of the additive manufacturing technique is capable of fabricating those features.

Aspects of the present disclosure relate to locally modifying sensitivity Dₚ and cure depth C_{d} in order to improve feature resolution and avoid undesirable cross-linking. According to some embodiments, light-absorbing materials and/or photoinitiators may be deposited on layer to tailor local sensitivity Dₚ and cure depth C_{d}.

FIG. 10 is a flowchart 1000 of a 3D printing method according to an example embodiment. The method may be performed, for example, by 3D printing system 100c of FIG. 4. 3D printing system 100c applies 1010 a layer of slurry. For example, MRS 320 may deposit a uniform (or near uniform) thickness layer of the photosensitive medium across the interior of the material build platform 300 without disturbing any previously built layers. During a part build, upon the completion of a layer exposure, the MRS 320 may quickly sweep the medium across the build area under computer system 330 control.

3D printing system 100c applies 1020 a photoinitiator and/or an absorber to a surface of the photosensitive medium. For example, depositor 440 may selectively and/or locally spray, print, or drip an absorber to portions of a surface where a sharp cutoff of curing is desired. The absorber may be, as a non-limiting example, a light absorbing dye. In some cases, depositor 440 may be an ink-jet printer (or other depositing mechanism as will be understood by one of ordinary skill) mounted on an XY scanning stage and/or tracks able to travel across surface 290. In some embodiments, depositor 404 may include an ink-jet printer (or other depositing mechanism as will be understood by one of ordinary skill) mounted on an articulating arm configured to reach various locations of the surface 290. The location and/or pattern of applying the photoinitiator and/or absorber may be determined (e.g., by computer system 330) derived from a slice image of a current or previous layer. The photoinitiator and/or an absorber can be molecularly tethered to the surface of the newly formed layer of photosensitive medium. The absorber can act as a “stop mask” to sharply cut off the propagation of lighter further into the underlying layers. As will be understood by one of ordinary skill, some layers may not require the addition of an absorber and/or photoinitiator.

After application 1020 of photoinitiator and/or an absorber, 3D printing system 100c selectively exposes 1030 the layer of photosensitive material with light. For example, optical imaging system 200 may selectively expose the surface 290 to light to cure a portion of the photosensitive material corresponding to a current slice of a desired 3D printed object. The light exposure 1030 can cause the desired degree of cure in the new layer. As will be understood, the light absorbing agent (e.g., dye molecules) present at the top of the underlying layer can quench the light arriving at that location from the top surface and thus dramatically attenuate the light propagating deeper into the underlying layers. Attenuating the light in this manner can reduce or prevent the phenomenon of print-through and improve the feature resolution in fabricated parts while avoiding curing in undesirable locations. In some cases, an absorber can be selectively printed at the boundaries of the contours of each layer to inhibit side-scattering, induced bleed, blurring or growth of the contours, all of which can affect dimensional accuracy by enlarging positive features, such as boundaries or fingers, and shrinking negative features, such as holes.

Meanwhile, a photoinitiator printed across the surface of a newly fabricated layer or a newly swept layer of photopolymerizable suspension can locally increase the photocuring reactivity of the suspension only in those regions where it is printed while keeping all other regions of the suspension at a nominal level. Thus, certain areas requiring enhanced curing (e.g., to ensure all photosensitive material in the area has been cured) may be cured at a higher rate than necessary for a remaining portion of the photosensitive material.

3D printing system 100c (e.g., computer system 330) determines 1040 whether a last layer has been printed. If so (1040-Yes), the 3D printing process ends 1090. If not (1040-No) the method returns to 1010 and MRS 320 applies 1010 another layer of slurry.

FIG. 11 is a flowchart 1100 of a 3D printing method according to an example embodiment. The method may be performed, for example, by 3D printing system 100c of FIG. 4. As can be seen, the method described with reference to FIG. 11 is substantially similar to the method described above with reference to FIG. 10 except that the 3D printing system 100c applies 1150 a photoinitiator and/or an absorber prior to applying 1160 a new layer of photosensitive material. Accordingly, a detailed repetition of similar elements is not repeated below. 3D printing system 100c selectively exposes 1130 a surface 290 of photosensitive material to light. 3D printing system 100c (e.g., computer system 330) determines 1140 whether a last layer has been printed. If so (1140-Yes), the 3D printing process ends 1190. If not (1140-No), 3D printing system 100c applies 1150 a photoinitiator and/or an absorber to a newly printed layer (and/or an uncured surface at the newly printed layer). 3D printing system 100c applies 1160 another layer of slurry and selectively exposes 1130 a surface 290 of the layer to light.

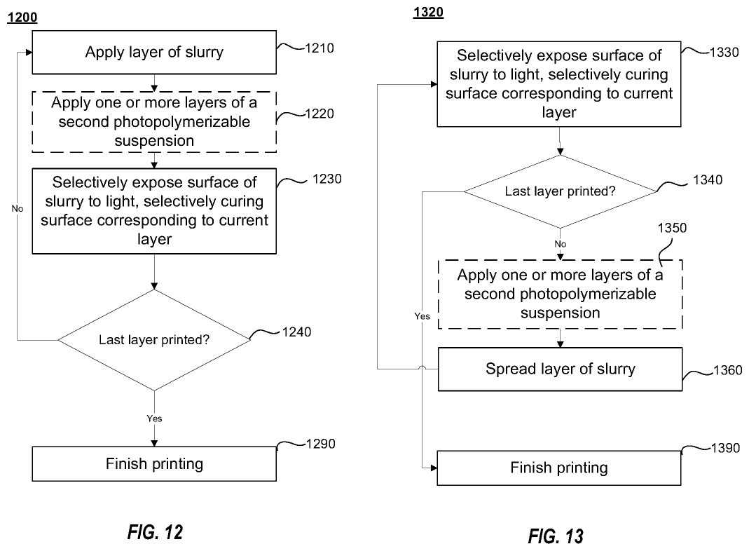

FIG. 12 is a flowchart 1200 of a 3D printing method according to an example embodiment. The method may be performed, for example, by 3D printing system 100c of FIG. 4. As can be seen, the method described with reference to FIG. 12 is substantially similar to the method described above with reference to FIG. 10 except that the 3D printing system 100c applies 1220 one or more layers of a second photopolymerizable suspension instead of applying 1020 an absorber and/or photoinitiator. Accordingly, a detailed repetition of similar elements is not repeated below.

3D printing system 100c applies 1210 a layer of slurry. Then, applies 1220 one or more layers of a second photopolymerizable suspension to a surface 290 of the slurry. For example, one or more layers of a second photopolymerizable suspension can be sprayed or inkjet printed onto the surface of the previously swept layer, similar to that of an absorber or photoinitiator as discussed above. The newly printed layer(s) can remain as a distinct surface layer and, upon photopolymerization, can provide a bi-layer or heterogeneous layered product. Such multi-layered products can provide additional benefits over homogenous products. In some cases, multiple layers of a photopolymerizable suspension can be spray coated or inkjet printed prior to photopolymerization to achieve a desired build layer thickness. Each layer can have a distinct uniform composition. Additionally, within each layer, there can be in-plane variations of composition.

After application 1220 of the one or more photopolymerizable suspension layers, 3D printing system 100c selectively exposes 1230 the layer of photosensitive material with light. 3D printing system 100c (e.g., computer system 330) determines 1240 whether a last layer has been printed. If so (1240-Yes), the 3D printing process ends 1290. If not (1240-No) the method returns to 1210 and MRS 320 applies 1210 another layer of slurry.

FIG. 13 is a flowchart 1300 of a 3D printing method according to an example embodiment. The method may be performed, for example, by 3D printing system 100c of FIG. 4. As can be seen, the method described with reference to FIG. 13 is substantially similar to the method described above with reference to FIG. 12 except that the 3D printing system 100c applies 1350 one or more layers of a second photopolymerizable suspension prior to applying 1360 a new layer of photosensitive material. Accordingly, a detailed repetition of similar elements is not repeated below. 3D printing system 100c selectively exposes 1330 a surface 290 of photosensitive material to light. 3D printing system 100c (e.g., computer system 330) determines 1340 whether a last layer has been printed. If so (1340-Yes), the 3D printing process ends 1390. If not (1340-No), 3D printing system 100c applies 1350 one or more layers of a second photopolymerizable suspension a newly printed (e.g., cured) layer (and/or an uncured surface at the newly printed layer). 3D printing system 100c applies 1360 another layer of slurry and selectively exposes 1330 a surface 290 of the layer to light.

One of ordinary skill will recognize that the various applying's 1020, 1150, 1220, and 1350 discussed above with reference to FIGS. 11-13 may be selectively combined. Accordingly, in some implementations, one or more layers of photoinitiations, absorbers, and/or second photopolymerizable suspensions may be deposited on a surface 290 before and/or after a new layer of photosensitive material is added to the surface 290.

### Geometric Fidelity

Additive Manufacturing (AM) techniques using photopolymerization to build objects (e.g., Large Area Maskless Photopolymerization (LAMP)), typically involve optical patterning of thin layers using an activating radiation, such as light of various wavelengths. The pattern for each layer can be created by appropriate software that converts a three-dimensional design of an object into a series of slices, with instructions for each slice serving as the pattern for light exposure (e.g., layer building). In AM by photopolymerization, the feature resolution in the build direction (the so-called z-direction) is determined by the layer thickness and the depth of cure. In the absence of optical scattering, the depth of cure is determined by the energy dose and the absorption of the activating radiation by the photopolymerizable material. Patterning within each layer of the material (x,y directions) can be done by projection of activating radiation corresponding to the artwork through a photomask, or through maskless projection using a spatial light modulator, or by using a scanning beam such as a laser. In non-scattering suspensions, the resolution in the layer direction (x,y) is determined by the resolution of the mask, or the resolution of the maskless projection device (such as the spatial light modulator), or by the size of the scanning beam in combination with the sensitivity of the photopolymerizable suspension (i.e. the tiniest feature that can be formed in the suspension through photopolymerization). Resolution limits in the (x,y) direction may also be diffraction-limited if the feature size is comparable to the wavelength of the radiation. In diffraction-limited cases, patterning errors can be reduced using methods known for fine scale lithographic patterning of single layers, such as Optical Proximity Correction (OPC) to modify the artwork.

AM by photopolymerization of powder suspensions involves scattering of the activating radiation if the refractive index of the suspended powder differs from the refractive index of the suspension medium. Resolution in photopatterning of suspensions can be degraded if the activating radiation develops sideways directed components in the (x,y) direction, for example, broadening, blooming, and/or blurring by scattering or other optical phenomena. Feature resolution is further affected by dimensional changes, such as shrinkage or swelling during polymerization, subsequent processing, or heat treatment. AM involves superposition of many photopatterned layers, and the patterning of a subsequent layer can influence the pattern of an earlier layer by “print-through.”

Aspects of the present disclosure relate to modifying image slices and/or light output based on known or determined qualities of the photosensitive medium (e.g., scattering or other optical phenomena, as well as dimensional changes during polymerization, subsequent processing, or heat treatment). According some embodiments may increase or decrease a surface area of one or more features to provide a higher fidelity 3D printed object.

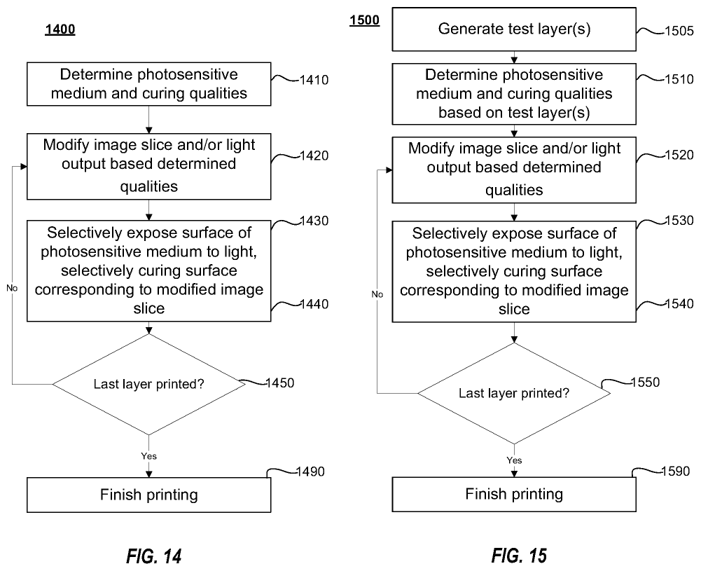

FIG. 14 is a flowchart 1400 of a 3D printing method according to an example embodiment. The method may be performed, for example, by 3D printing system 100 of any of FIGS. 2-5. 3D printing system 100 determines 1410 photosensitive medium and/or curing properties. For example, computer system 330 may receive/retrieve information about the properties of the photopolymerizable suspension. In some cases, computer system 330 may utilize physics-based simulations (e.g., utilizing Monte-Carlo algorithms) to estimate the photosensitive medium and/or curing properties. As non-limiting examples, the photosensitive medium and/or curing properties may include light scattering, side scattering, shrinkage, print-through, curing expansions, polymerization shrinkage, sintering shrinkage, as well as changes due to subsequent processing and/or heat treatment. The photosensitive medium and/or curing properties may include one or more of broadening behavior of the suspension, optical properties of the suspension medium, such as its absorption coefficient and refractive index, and/or optical properties of powders in suspension, including the absorption and refractive index, as well as the powder particle size distribution, and other factors that can affect broadening.

3D printing system 100 modifies 1420 the image slice based on the determined photosensitive medium and/or curing properties. Non-analogous approaches in Optical Proximity Correction (OPC) of diffraction phenomena in semiconductor lithography may inform specific correction designs. For example, computer system 330 may execute algorithms and/or software for Layerwise Slice Geometry Correction (LSGC), which can correct the artwork in the slice files to improve resolution (i.e., by correcting for phenomena and properties). In some embodiments, computer system 330 may modify 1420 the slice files by changing dimensions and shapes to yield improved fidelity to the design intent geometry. For example, computer system 330 may make positive and/or negative boundary corrections to enhance resolution of the image slice. Non-limiting examples of geometry-specific corrections include keyholes for corners and comparable corrections for other features, designed in light of the different physics of the optical phenomena involved in photopolymerization of suspensions. In some cases, computer system 330 may alter a light intensity (e.g., locally or globally) to adjust for the properties. Computer system 330 may modify 1420 the image slice by scaling feature sizes to compensate for dimensional changes due to shrinkages or expansions, including polymerization shrinkage, sintering shrinkage, or both. Thus, computer system 330 can make corrections such that the final target geometry is achieved through the step of photopolymerization alone, sintering alone, or both. Such shrinkages are known to be anisotropic, requiring appropriate scaling in the x,y, and z directions and rotations in all three dimensions.

After modifying 1420 the image slice, 3D printing system 100 selectively exposes 1430 the layer of photosensitive material with light. For example, optical imaging system 200 may selectively expose the surface 290 to light to cure a portion of the photosensitive material in accordance with the modified image slice. The light exposure 1430 can cause the desired degree of cure in the new layer.

3D printing system 100 (e.g., computer system 330) determines 1440 whether a last layer has been printed. If so (1450-Yes), the 3D printing process ends 1490. Although the modified image slice(s) may not appear the same as the desired image slice, by compensating for the photosensitive medium and/or curing properties, the final object has higher fidelity to a desired geometry. If not (1450-No) the method MRS 320 applies another layer of photosensitive material and 3D printing system 100 builds a next layer based on a next slice (or modified slice).

FIG. 15 is a flowchart 1500 of a 3D printing method according to an example embodiment. The method may be performed, for example, by any 3D printing system 100 of FIGS. 2-5. As can be seen, the method described with reference to FIG. 15 is substantially similar to the method described above with reference to FIG. 14 except that the 3D printing system 100 applies determines 1510 photosensitive medium and/or curing properties based on printed test layer(s) 1505. Accordingly, a detailed repetition of similar elements is not repeated below. 3D printing system 100 generates 1505 test layers, for example, based on calibration images. Generating 1505 the test layers may involve selectively exposing a surface 290 of the photosensitive medium with light corresponding to one or more calibration images.

3D printing system 100 determines 1410 photosensitive medium and/or curing properties based on comparing the test layers to the calibration images. For example, 3D printing system 100 may determine geometries of the test layers and compare them to the geometries of the calibration images. By comparing the geometries (and determining differences there between), 3D printing system 100 (e.g., computing system 330) may estimate the properties of the photosensitive medium. In some cases, image capturing device(s) 550 may capture image data of the test layers, and computing system 330 may analyze the images to determine a geometry of the test layers. However, this is merely an example and one of ordinary skill would recognize, in light of the present disclosure, that the geometry of the test layers may be determined in various additional ways without departing from the present disclosure. In some implementations, dimensions of the test images and/or intensities of the light may be varied over a plurality of test layers (e.g., in layer-by-layer fashion or by multiple separated test layers), and properties of the photosensitive medium may be determined based on geometry comparisons over the variations.

3D printing system 100 modifies 1520 the image slice based on the determined photosensitive medium and/or curing properties and selectively exposes 1530 a surface 290 of photosensitive material to light in accordance with the modified image slice. 3D printing system 100 (e.g., computer system 330) determines 1540 whether a last layer has been printed. If so (1550-Yes), the 3D printing process ends 1590. If not (1550-No), 3D printing system 100 applies 1150 a photoinitiator and/or an absorber to a newly printed layer (and/or an uncured surface at the newly printed layer). If not (1550-No) the method MRS 320 applies another layer of photosensitive material and 3D printing system 100 builds a next layer based on a next slice (or modified slice).

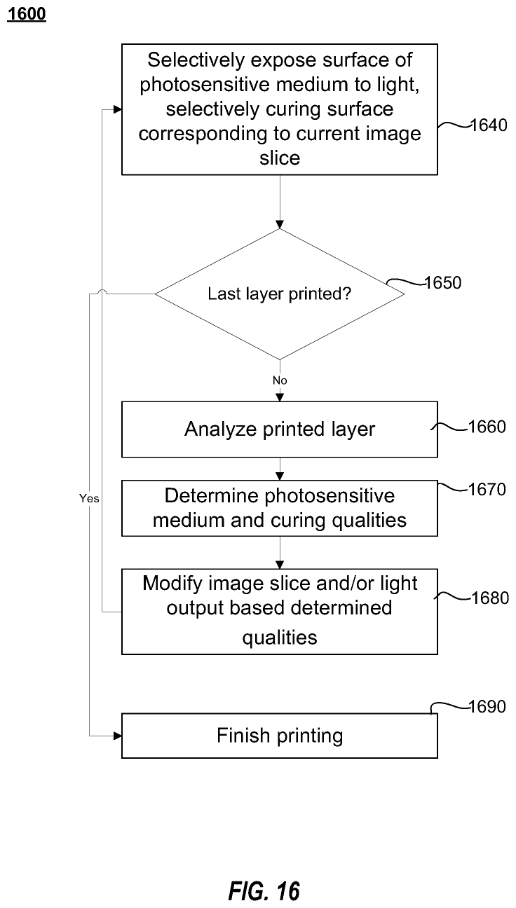

FIG. 16 is a flowchart 1600 of a 3D printing method according to an example embodiment. The method may be performed, for example, by 3D printing system 100d of FIG. 5. As can be seen, the method described with reference to FIG. 16 has overlap with the method described above with reference to FIG. 14 except that the 3D printing system 100d analyzes 1660 previously printed layers to determine 1670 photosensitive medium and/or curing properties. Accordingly, a detailed repetition of similar elements is not repeated below.

3D printing system 100d selectively exposes 1640 a surface 290 of photosensitive material to light based on a current image slice. 3D printing system 100d (e.g., computer system 330) determines 1650 whether a last layer has been printed. If so (1650-Yes), the 3D printing process ends 1690. If not (1650-No), 3D printing system 100d analyzes 1660 a previously printed layer (e.g., a most recently cured layer). Analyzing 1660 the printed layer may involve determining geometries of the printed layer and comparing the geometries to desired geometries. In some cases, such geometrics may be gathered from image capturing device 550 and an unmodified image slice, respectively.

Based on the analysis 1660, 3D printing system 100d (e.g., computer system 330) determines 1670 the photosensitive medium qualities, and modifies 1680 a next image slice based on the determined qualities. Such determination 1670 and modification 1680 may eb substantially similar the determination 1510 and modification 1420/1520 discussed above with reference to FIGS. 14 and 15. 3D printing system 100d then prints a next layer (e.g., by exposing 1640 a surface 290 of photosensitive material to light based on a modified image slice).

In some embodiments, each layer may be observed, and computing system 330 may estimate the photosensitive medium and/or curing properties based on a plurality of earlier layers (look behind), subsequent layers (look ahead).

One of ordinary skill will recognize that the various bases for determining photosensitive medium and/or curing properties, as discussed above with reference to FIGS. 14-16 may be selectively combined. Accordingly, in some implementations, known (or predicted) values, tested values (e.g., from calibration images), and/or monitored values (e.g., form layer monitoring during 3D printing) may be used to estimate and/or revise photosensitive medium and/or curing properties, which can then be used to modify image slices.

Furthermore, one of ordinary skill will recognize, in light of the present disclosure, that the various techniques describes herein may be combined without departing from the scope of the present disclosure. For example, in a single 3D printing process, a cast file may be modified to include an internal structure (e.g., microstructure) and modified to compensate for properties of the photosensitive medium. Further, in a single 3D printing process, a cast file may be modified to include an internal structure (e.g., microstructure) and, during printing, layers of absorbers, photoinitiations, and/or second photosensitive mediums may be deposited between layers of the photosensitive medium. Additionally, in a single 3D printing process, a cast file may be modified to compensate for properties of the photosensitive medium and, during printing, layers of absorbers, photoinitiations, and/or second photosensitive mediums may be deposited between layers of the photosensitive medium. Similarly, in a single 3D printing process, a cast file may be modified to include an internal structure (e.g., microstructure), the cast file may eb further modified to compensate for properties of the photosensitive medium, and, during printing, layers of absorbers, photoinitiations, and/or second photosensitive mediums may be deposited between layers of the photosensitive medium.

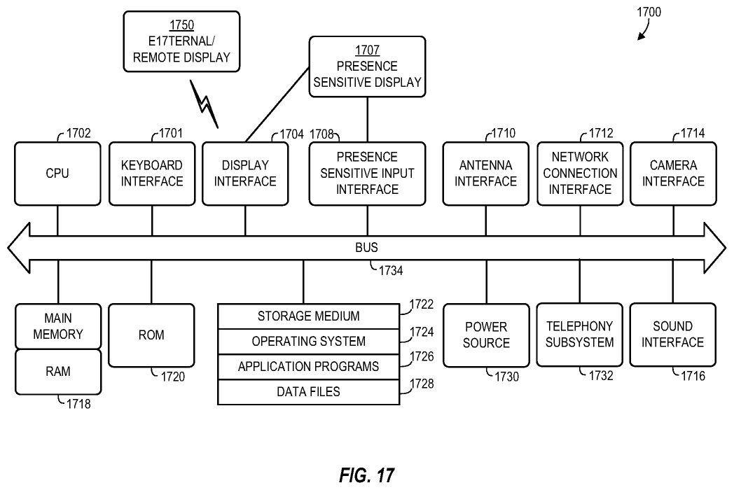

Aspects of the disclosed technology may be implemented using at least some of the components illustrated in the computing device architecture 1700 of FIG. 17. For example, portions of 3D printing system 100a-100d, such as computer system 330 and image capturing devices, may be implemented with one or more of the components depicted in FIG. 17. As shown, the computing device architecture 1700 includes a central processing unit (CPU) 1702, where computer instructions are processed; a display interface 1704 that acts as a communication interface and provides functions for rendering video, graphics, images, and texts on the display. In certain example implementations of the disclosed technology, the display interface 1704 may be directly connected to a local display, such as a touch-screen display associated with a mobile computing device. In another example implementation, the display interface 1704 may be configured for providing data, images, and other information for an external/remote display that is not necessarily physically connected to the mobile computing device. For example, a desktop monitor may be utilized for mirroring graphics and other information that is presented on a mobile computing device. In certain example implementations, the display interface 1704 may wirelessly communicate, for example, via a Wi-Fi channel or other available network connection interface 1712 to the external/remote display.

In an example implementation, the network connection interface 1712 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 1704 may be operatively coupled to a local display, such as a touch-screen display associated with a mobile device. In another example, the display interface 1704 may be configured to provide video, graphics, images, text, other information, or any combination thereof for an external/remote display that is not necessarily connected to the mobile computing device. In one example, a desktop monitor may be utilized for mirroring or extending graphical information that may be presented on a mobile device. In another example, the display interface 1704 may wirelessly communicate, for example, via the network connection interface 1712 such as a Wi-Fi transceiver to the external/remote display.

The computing device architecture 1700 may include a keyboard interface 1706 that provides a communication interface to a keyboard. In one example implementation, the computing device architecture 1700 may include a presence-sensitive display interface 1708 for connecting to a presence-sensitive display 1707. According to certain example implementations of the disclosed technology, the presence-sensitive display interface 1708 may provide a communication interface to various devices such as a pointing device, a touch screen, a depth camera, etc. which may or may not be associated with a display.

The computing device architecture 1700 may be configured to use an input device via one or more of input/output interfaces (for example, the keyboard interface 1706, the display interface 1704, the presence sensitive display interface 1708, network connection interface 1712, camera interface 1714, sound interface 1716, etc.,) to allow a user to capture information into the computing device architecture 1700. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 1700 or may be a separate device. For example, the input device may be an accelerometer, a magnetometer, a digital camera, a microphone, and an optical sensor.

Example implementations of the computing device architecture 1700 may include an antenna interface 1710 that provides a communication interface to an antenna; a network connection interface 1712 that provides a communication interface to a network. As mentioned above, the display interface 1704 may be in communication with the network connection interface 1712, for example, to provide information for display on a remote display that is not directly connected or attached to the system. In certain implementations, a camera interface 1714 is provided that acts as a communication interface and provides functions for capturing digital images from a camera. In certain implementations, a sound interface 1716 is provided as a communication interface for converting sound into electrical signals using a microphone and for converting electrical signals into sound using a speaker. According to example implementations, a random-access memory (RAM) 1718 is provided, where computer instructions and data may be stored in a volatile memory device for processing by the CPU 1702.

According to an example implementation, the computing device architecture 1700 includes a read-only memory (ROM) 1720 where invariant low-level system code or data for basic system functions such as basic input and output (I/O), startup, or reception of keystrokes from a keyboard are stored in a non-volatile memory device. According to an example implementation, the computing device architecture 1700 includes a storage medium 1722 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 1724, application programs 1726 (including, for example, a web browser application, a widget or gadget engine, and or other applications, as necessary) and data files 1728 are stored. According to an example implementation, the computing device architecture 1700 includes a power source 1730 that provides an appropriate alternating current (AC) or direct current (DC) to power components.

According to an example implementation, the computing device architecture 1700 includes and a telephony subsystem 1732 that allows the device 1700 to transmit and receive sound over a telephone network. The constituent devices and the CPU 1702 communicate with each other over a bus 1734.

According to an example implementation, the CPU 1702 has appropriate structure to be a computer processor. In one arrangement, the CPU 1702 may include more than one processing unit. The RAM 1718 interfaces with the computer bus 1734 to provide quick RAM storage to the CPU 1702 during the execution of software programs such as the operating system application programs, and device drivers. More specifically, the CPU 1702 loads computer-executable process steps from the storage medium 1722 or other media into a field of the RAM 1718 in order to execute software programs. Data may be stored in the RAM 1718, where the data may be accessed by the computer CPU 1702 during execution. In one example configuration, the device architecture 1700 includes at least 178 MB of RAM, and 256 MB of flash memory.

The storage medium 1722 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 1722, which may include a machine-readable storage medium.

According to one example implementation, the term computing device, as used herein, may be a CPU, or conceptualized as a CPU (for example, the CPU 1702 of FIG. 17). In this example implementation, the computing device (CPU) may be coupled, connected, and/or in communication with one or more peripheral devices, such as display. In another example implementation, the term computing device, as used herein, may refer to a mobile computing device such as a smartphone, tablet computer, or smart watch. In this example embodiment, the computing device may output content to its local display and/or speaker(s). In another example implementation, the computing device may output content to an external display device (e.g., over Wi-Fi) such as a TV or an external computing system.

In example implementations of the disclosed technology, a computing device may include any number of hardware and/or software applications that are executed to facilitate any of the operations. In example implementations, one or more I/O interfaces may facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1-133. (canceled)

134. A system for fabricating a three-dimensional object, the system comprising:
an optical light source;
a reservoir configured to hold a liquid photosensitive medium that is adapted to change states upon exposure to a portion of light from the optical light source; and
a control system configured to:
determine at least one photosensitive medium and curing property; and
control the optical light source to expose specified portions of a surface of the photosensitive medium contained in the reservoir to light from the optical light source.

135. The system of claim 134, wherein the control system is further configured to:
modify an intensity of the optical light source based on the at least one photosensitive medium and curing property; and
control the optical light source to expose the specified portions of a surface of the photosensitive medium contained in the reservoir to light from the optical light source with the modified intensity.

136. The system of claim 134, wherein the control system is further configured to:
modify an image slice based on the at least one photosensitive medium and curing property; and
control the optical light source to expose the specified portions of a surface of the photosensitive medium contained in the reservoir to light from the optical light source based on the modified image slice.

137. The system of claim 136, wherein modifying the image slice comprises at least one of making positive and/or negative boundary corrections of the image slice and inserting a keyhole for a corner of the image slice.

138. The system of claim 134, wherein the photosensitive medium and curing property comprises at least one from among light scattering, side scattering, shrinkage, print-through, curing expansions, polymerization shrinkage, sintering shrinkage, broadening behavior of a suspension medium of the photosensitive medium, optical properties of the suspension medium, absorption coefficient of the suspension medium, refractive index of the suspension medium, optical properties of powders in the suspension medium, absorption of the powders in the suspension medium, refractive index of the powders in the suspension medium, powder particle size distribution, changes due to subsequent processing and/or heat treatment.

139. The system of claim 134, wherein the control system is further configured to determine the at least one photosensitive medium and curing property by performing physics-based simulations to estimate the at least one photosensitive medium and curing property.

140. The system of claim 134, wherein the control system is further configured to determine the at least one photosensitive medium and curing property by retrieving stored information about the at least one photosensitive medium and curing property.

141. The system of claim 134, wherein the control system is further configured to control the optical light source to expose specified portions of a surface the photosensitive medium contained in the reservoir to light from the optical light source based on one or more calibration images to form one or more test layers.

142. The system of claim 141 further comprising one or more image capturing devices,
wherein the control system is further configured to control the one or more image capturing devices to capture a geometry of the one or more test layers.

143. The system of claim 142, wherein the control system is further configured to compare the captured geometry of the one or more test layers to the one or more calibration images to determine the at least one photosensitive medium and curing property.

144. The system of claim 142, wherein the one or more image capturing devices comprises at least one from among a camera, an infrared sensor, a laser grid emitter, and a three-dimensional (3D) scanner.

145. The system of claim 134 further comprising one or more image capturing devices,
wherein the control system is further configured to:
control the one or more image capturing devices to capture a geometry of one or more cured layers;
compare the captured geometry of the one or more cured layers to an intended geometry of the one or more cured layers; and
determine the at least one photosensitive medium and curing property based on the comparison.

146. A method for fabricating a three-dimensional object, the method comprising:
determining a geometry of a current layer;
determining at least one photosensitive medium and curing property; and
controlling a curing light source to expose specified portions of a surface of photosensitive medium to light from the light source consistent with the geometry of the current layer.

147. The method of claim 146 further comprising modifying an intensity of the light source based on the at least one photosensitive medium and curing property, the controlling the light source comprising controlling the light source to expose the specified portions of the surface of photosensitive medium to light from the light source with the modified intensity.

148. The method of claim 146 further comprising modifying an image slice based on the at least one photosensitive medium and curing property, the controlling the light source being based on the modified image slice.

149. The method of claim 148, wherein modifying the image slice comprises at least one of making positive and/or negative boundary corrections of the image slice and inserting a keyhole for a corner of the image slice.

150. The method of claim 146, wherein determining the at least one photosensitive medium and curing property comprises performing physics-based simulations to estimate the at least one photosensitive medium and curing property.

151. The method of claim 146, wherein determining the at least one photosensitive medium and curing property comprises retrieving stored information about the at least one photosensitive medium and curing property.

152. The method of claim 146 further comprising:
exposing the surface of the photosensitive medium to light from the light source in accordance with one or more calibration images to form one or more test layers;
capturing a geometry of the one or more test layers; and
comparing the captured geometry of the one or more test layers to the one or more calibration images to determine the at least one photosensitive medium and curing property.

153. The method of claim 146 further comprising:
capturing a geometry of one or more cured layers;
comparing the captured geometry of the one or more cured layers to an intended geometry of the one or more cured layers; and
determining the at least one photosensitive medium and curing property based on the comparison.
